(19) United States
(12) Patent Application Publication
(10) Pub. No.: US 2017/0182913 A1
(43) Pub. Date: Jun. 29, 2017

(54) METHOD FOR CONTROLLING VEHICLE SEAT AND DEVICE FOR CONTROLLING VEHICLE SEAT

(71) Applicant: AISIN SEIKI KABUSHIKI KAISHA, Kariya-shi (JP)

(72) Inventors: Norikazu URATSUJI, Takahama-shi (JP); Miho YARIMIZU, Nagoya-shi (JP); Takashi KAINO, Anjo-shi (JP)

(73) Assignee: AISIN SEIKI KABUSHIKI KAISHA, Kariya-shi (JP)

(21) Appl. No.: 15/378,654

(22) Filed: Dec. 14, 2016

(30) Foreign Application Priority Data
Dec. 24, 2015 (JP) 2015-252170

(51) Int. Cl. B60N 2/02; B60N 2/22; B60N 2/06

(52) U.S. Cl. CPC B60N 2/0244; B60N 2/06; B60N 2/22

(57) ABSTRACT

A method for controlling a vehicle seat includes: detecting a partial opening operation that a slide door which is provided in a side surface of a vehicle operates from a fully closed position to a position in the middle of reaching a fully opened position of the slide door; and controlling an operation of the seat which is provided in a vehicle interior in order to form a luggage disposition portion on a position on which luggage is loadable through door opening of a side surface of the vehicle which is formed by the partial opening operation, in a case where the slide door performs the partial opening operation.

### CROSS REFERENCE TO RELATED APPLICATIONS

This application is based on and claims priority under 35 U.S.C. §119 to Japanese Patent Application 2015-252170, filed on Dec. 24, 2015, the entire contents of which are incorporated herein by reference.

### TECHNICAL FIELD

This disclosure relates to a method for controlling a vehicle seat and a device for controlling a vehicle seat.

### BACKGROUND DISCUSSION

In the related art, in a slide door device for a vehicle which has a drive source and opens and closes a slide door, for example, as described in JP 2012-36569A (Reference 1), there is a device which performs partial opening of the slide door from a fully closed position to a position in the middle of reaching a fully opened position by changing an input method of opening operation request.

In other words, as illustrated in FIG. 16, there are many cases where a slide door 85 is not always necessary to be moved to the fully opened position, when loading and unloading of luggage 84 are performed through a door opening portion 83 of a vehicle 81. Further, time which is required for an opening operation and a closing operation can be reduced by an operation amount of the slide door 85 being reduced. In addition, accordingly, reduction of heating and cooling efficiency due to the opening operation of the slide door 85 can be suppressed. In particular, in rainy weather, introduction of rainwater into a vehicle interior 87 facing the outside of the vehicle through a door opening 86 can be suppressed. Even when the slide door 85 is closed, there is an advantage that a door handle 88 of a vehicle is in a position which is close to a user.

Based on this point, the slide door device (door opening and closing driving device) described in Reference 1 can be set a partial opening operation of the slide door, by a single operating input which is performed in a state where the slide door is in the fully closed position, without performing the operation input again in the middle of movement. Accordingly, improvement in the convenience of the slide door is achieved.

However, an area which is loadable luggage in a vehicle interior through a door opening is also narrowed as an opening operation amount of a slide door becomes smaller. Accordingly, since there is a possibility that a location on which the luggage is disposed is difficult to be secured, there is room for improvement with respect to this point.

### SUMMARY

Thus, a need exists for a method for controlling a vehicle seat and a device for controlling a vehicle seat which are not suspectable to the drawback mentioned above.

It is preferable that a method for controlling a vehicle seat according to an aspect of this disclosure includes detecting a partial opening operation that a slide door which is provided in a side surface of a vehicle operates from a fully closed position to a position in the middle of reaching a fully opened position of the slide door; and controlling an operation of the seat which is provided in a vehicle interior in order to form a luggage disposition portion on a position on which the luggage is loadable through door opening of a side surface of the vehicle which is formed by the partial opening operation, in a case where the slide door performs the partial opening operation.

It is preferable that a device for controlling a vehicle seat according to another aspect of this disclosure includes a partial opening operation detecting portion which detects a partial opening operation that a slide door which is provided in a side surface of a vehicle operates from a fully closed position to a position in the middle of reaching a fully opened position of the slide door; and a seat controlling unit which controls an operation of the seat which is provided in a vehicle interior so that a luggage disposition portion is formed on a position on which the luggage is loadable through door opening of a side surface of the vehicle which is formed by the partial opening operation, in a case where the slide door performs the partial opening operation.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view illustrating a slide door which performs a partial opening operation and a seat in a vehicle interior;

FIG. 2 is a schematic plan view illustrating a disposition of each seat which is provided in the vehicle interior and the slide door which performs partial opening operation;

FIG. 3 is a schematic configuration view illustrating a device for controlling the seat and a slide door device;

FIG. 4 is a flow chart illustrating a processing procedure of a slide door opening operation control;

FIG. 5 is a perspective view illustrating a partial opening operation of the slide door and a state in which a user loads luggage in the vehicle interior through a partial door opening;

FIG. 6 is a side view illustrating an aspect which forms and controls a luggage disposition portion in a first embodiment;

FIG. 7 is a plane view illustrating the aspect which forms and controls the luggage disposition portion in the first embodiment;

FIG. 8 is a flow chart illustrating a processing procedure of forming and controlling the luggage disposition portion in the first embodiment;

FIG. 9 is a side view illustrating an aspect which forms and controls a luggage disposition portion in a second embodiment;

FIG. 10 is a plan view illustrating the aspect which forms and controls the luggage disposition portion in the second embodiment;

FIG. 11 is a flow chart illustrating a processing procedure of forming and controlling the luggage disposition portion in the second embodiment;

FIG. 12 is a plan view illustrating an aspect which forms and controls a luggage disposition portion in another example;

FIG. 13 is a flow chart illustrating an aspect which forms and controls a luggage disposition portion in still another example;

FIG. 14 is a flow chart illustrating an aspect which forms and controls a luggage disposition portion in still another example;

FIG. 15A to FIG. 15C are side views illustrating aspects which form and control a luggage disposition portion in a still another example; and

FIG. 16 is a perspective view illustrating a partial opening operation of the slide door and a state in which a user loads the luggage in the vehicle interior through the partial door opening.

### DETAILED DESCRIPTION

### First Embodiment

Hereinafter, a first embodiment related to a method for controlling a vehicle seat and a device for controlling a vehicle seat will be described with reference to drawings.

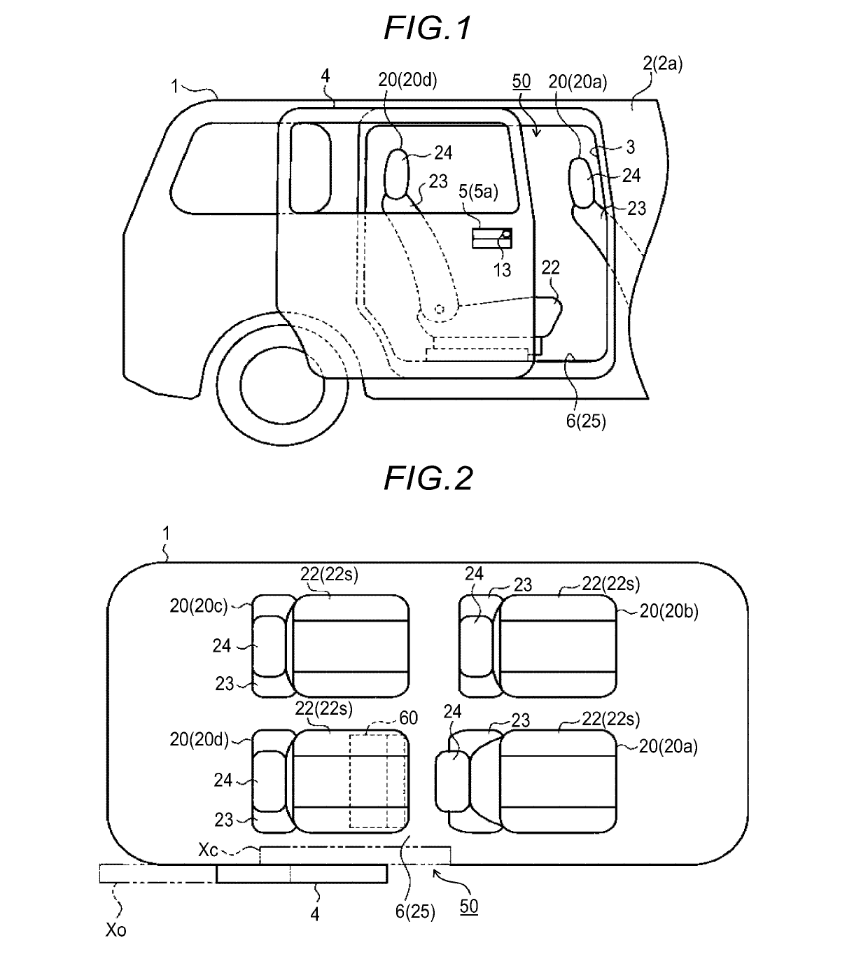

As illustrated in FIG. 1 and FIG. 2, in a vehicle 1 according to the present embodiment, a door opening portion 3 which is provided in a side surface 2a of a vehicle body 2 includes a slide door 4 which is capable of opening and closing the door opening portion 3 by moving in a front direction and a rear direction of the vehicle (right and left directions in FIG. 1).

Specifically, the slide door 4 is in a fully closed state which closes the door opening portion 3 of the vehicle by moving in a front direction of the vehicle (right direction in each drawing) and is in a fully opened state in which an occupant is capable of getting on and off the vehicle through the door opening portion 3 of the vehicle by moving in a rear direction of the vehicle (left direction in each drawing). A door handle 5 for opening and closing the slide door 4 is provided in the slide door 4.

In other words, the slide door 4 according to the embodiment is released from a locked state by a locking device (not illustrated) by operating the door handle 5. In addition, the slide door 4 can be released from the locked state by the locking device by also operating an operating switch which is provided in a vehicle interior 6 or an operating input portion of a portable device or the like. The slide door 4 according to the embodiment can be opened and closed using the door handle 5 thereof as a grasping portion.

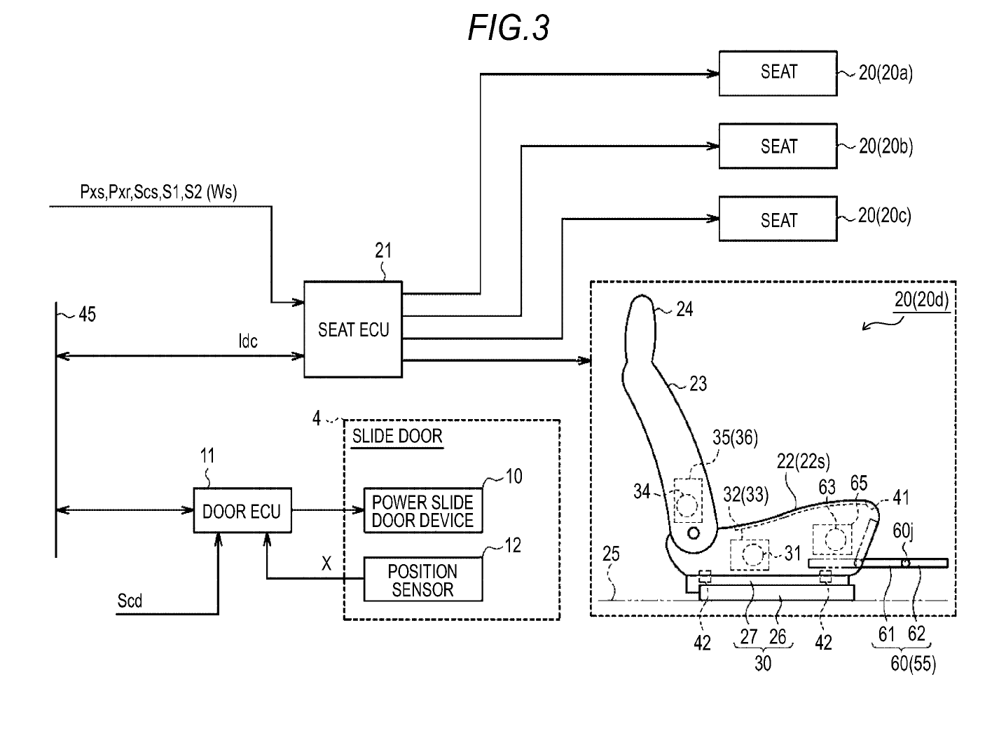

In addition, as illustrated in FIG. 3, a power slide door device 10 using a motor (not illustrated) as a driving source is provided in the slide door 4 according to the embodiment. The slide door 4 according to the embodiment can be opened and closed based on the operation of the power slide door device 10.

Specifically, the operation of the power slide door device 10 according to the present embodiment is controlled by a door ECU 11. Specifically, the door ECU 11 detects a moved position X of the slide door 4, based on an output signal of a position sensor 12 which is provided in a driving portion of the slide door 4, specifically the power slide door device 10. In addition, an operating input signal Scd which indicates that another operating input portion which opens and closes the slide door 4 such as the door handle 5, the portable device, or the like is operated is input to the door ECU 11. The door ECU 11 according to the present embodiment is configured to control the operation of the power slide door device 10 so that the slide door 4 is opened and closed according to an operation request which is indicated in the operating input signal Scd.

For example, the door ECU 11 according to the present embodiment allows the slide door 4 to be moved to a fully opened position Xo in a case where an operating switch 13 (see FIG. 1) which is provided in an outside door handle 5a is continuously pressed more than a predetermined time, that is, in a case of so called “long pressing operation”, in a case where the slide door 4 in a fully closed position Xc. In a case where the slide door 4 is in the fully opened position Xo, in a case where the operating switch 13 is pressed, the slide door 4 is configured to be moved to the fully closed position Xc.

In addition, in a case where the slide door 4 is in the fully closed position Xc, in a case where there is a continuous pressing operation on the operating switch 13 and time of the continuously pressing operation is less than the predetermined time to fully open the operating slide door 4, the door ECU 11 according to the embodiment performs partial opening of the slide door 4 from the fully closed position Xc to a position in the middle of reaching the fully opened position Xo (see FIG. 1 and FIG. 2). In other words, in a case of so called “short pressing operation”, the partial door opening operating control of the slide door 4 is performed. The vehicle 1 according to the embodiment is configured to be loadable luggage in the vehicle interior 6 through the door opening of the side surface of the vehicle (partial door opening 50) which is formed by the partial opening operation of the slide door 4.

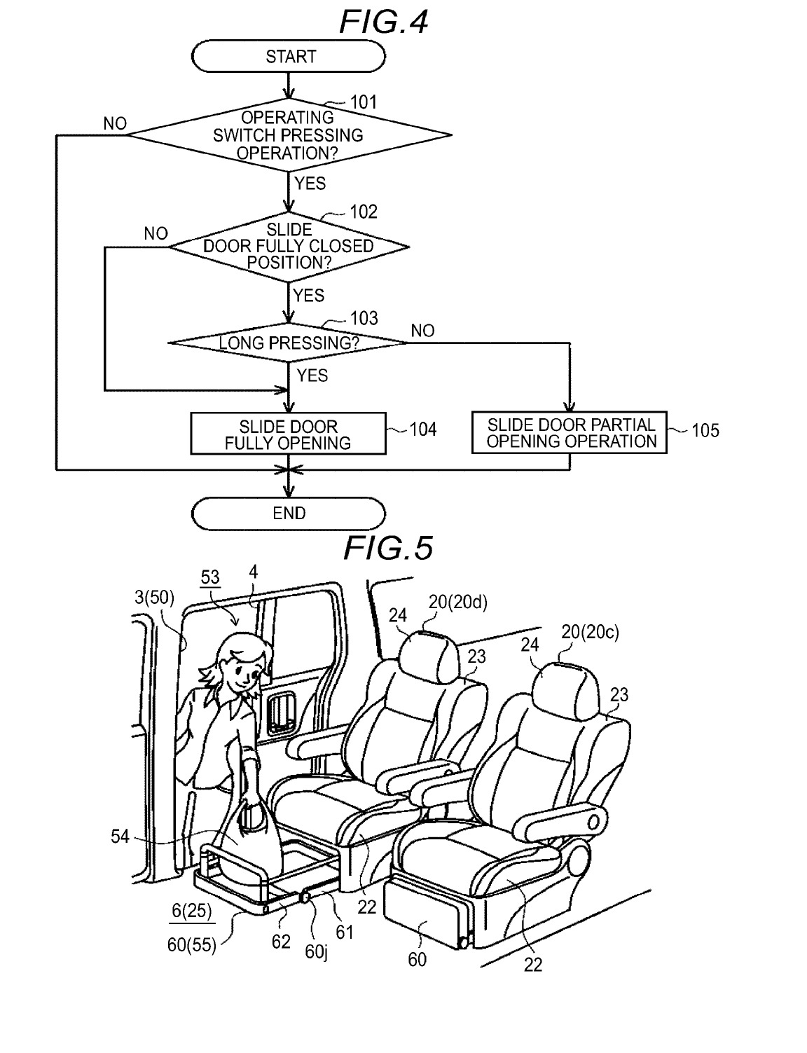

Specifically, as illustrated in a flow chart in FIG. 4, the door ECU 11 according to the embodiment first determines whether or not the slide door 4 is in the fully closed position Xc (step 102), in a case where the pressing operation on the operating switch 13 is detected (step 101: YES). Further, in a case where the slide door 4 is in the fully closed position Xc (step 102: YES), the door ECU 11 determines whether or not the pressing operation detected in step 101 is “long pressing operation” (step 103). In a case where the pressing operation is “long pressing operation” (step 103: YES), the door ECU 11 controls the operation of the power slide door device 10 so that the slide door 4 is moved to the fully opening position Xo (step 104).

On the other hand, in a case where the pressing operation of the door ECU 11 is not “long pressing operation” in step 103, that is, is “short pressing operation” (step 103: NO), the door ECU 11 controls the operation of the power slide door device 10 so that the slide door 4 performs the partial opening operation from the fully closed position Xc to the position in the middle of reaching the fully opening position Xo (partial opening operation, step 105). In step 102, even in a case where the slide door 4 is not in the fully closed position Xc (step 102: NO), in step 104, the door ECU 11 according to the embodiment is configured to control the operation of the power slide door device 10 so that the slide door 4 is moved to the fully opening position Xo.

In addition, as illustrated in FIG. 2 and FIG. 3, in the vehicle 1 according to the embodiment, each seat 20 (20a to 20d) which is provided in the vehicle interior 6 is a power seat which is operated by the motor driving, respectively. The operation of each seat 20 is independently controlled, respectively by the seat ECU 21.

Specifically, as illustrated in FIG. 3, each seat 20 includes a seat cushion 22 forming a seating surface of the seat 20 and a seat back 23 which is provided to be tillable to a rear end portion of the seat cushion 22. A headrest 24 is provided in an upper end portion of the seat back 23.

In addition, a pair of right and left lower rails 26 which extends in the front direction and the rear direction of the vehicle, respectively is provided in four locations which correspond to a front portion seat and a rear portion seat in the floor portion 25 of the vehicle interior 6. Further, upper rails 27 which are relatively movable on the lower rails 26 along the extending direction thereof are mounted on the lower rails 26, respectively. Each seat 20 is supported on the upper side of a seat slide rail 30 which forms each lower rail 26 and upper rail 27.

In other words, in a manner straddling the right and left seat slide rails 30, respectively, each seat 20 is fixed to the upper rail 27. In addition, a seat slide actuator 32 which allows the relative position of the upper rail 27 to the lower rail 26 to be changed using a motor 31 as a driving source is provided in the each seat 20, respectively. In the present embodiment, accordingly, a power seat slide device 33 by which the slide position of each seat 20 is adjustable in the front direction and the rear direction of the vehicle is formed.

In addition, a seat reclining actuator 35 using a motor 34 as a driving source is provided in each seat 20 according to the embodiment, respectively. In the embodiment, a power seat reclining device 36 which is capable of adjusting a tilting angle of the seat back 23 to the seat cushion 22 based on operation of the seat reclining actuator 35 is formed.

On the other hand, the seat ECU 21 according to the embodiment detects a slide position Pxs and a reclining position Pxr of each seat 20 (20a to 20d) by counting the output signal of pulse sensors which are provided in a driving portion of the seat slide actuator 32 and a driving portion of the seat reclining actuator 35. In addition, the operating input signal Scs which indicates the operating input to the operating switch (not illustrated) which is provided in each seat 20 is input to the seat ECU 21. The seat ECU 21 according to the embodiment is configured to control the operation of the power seat slide device 33 and the power seat reclining device 36 so that the slide position Pxs and the reclining position Pxr of each seat 20 (20a to 20d) are changed, based on operation request indicated in the operating input signal Scs.

In addition, each seat 20 according to the embodiment includes a seating sensor 41 which forms a pressure-sensitive portion on a seating surface 22s of the seat cushion 22 and a load sensor 42 which detects seat load Ws of the seat cushion 22. Specifically, in the seating sensor 41 according to the present embodiment, a membrane switch of which ON/OFF state is switched by the seating surface 22s being pressed is used. In addition, a strain sensor which is interposed between (a frame of) the seat cushion 22 and the upper rail 27 is used in the load sensor 42. The seat ECU 21 according to the embodiment is configured to detect a seating state of an occupant and presence or absence of a placed object in each sensor 20, based on an output signal S1 of the seating sensor 41 and output signal S2 (Ws) of the load sensor 42.

Further, in the vehicle 1 according to the embodiment, the door ECU 11 and the seat ECU 21 are connected to each other through an in-vehicle network 45. The seat ECU 21 according to the embodiment is configured to use control information Idc of the slide door 4 obtained from the door ECU 11 to the operating information of each seat 20 by mutual communication through the in-vehicle network 45.

Specifically, the seat ECU 21 according to the embodiment detects the partial opening operation of the slide door 4 as illustrated in FIG. 1 and FIG. 2, specifically start of the partial opening operation control which is performed by the door ECU 11, based on the control information Idc of the slide door 4 obtained from the door ECU 11.

Further, as illustrated in FIG. 5, in a case where the partial opening operation of the slide door 4 is detected, the seat ECU 21 according to the embodiment controls operation of each seat 20 which is provided in the vehicle interior 6 so that a luggage disposition portion 55 is formed on a position which is loadable luggage 54 in the vehicle interior 6 by a user 53 through the partial door opening 50 formed as described above (forming control of luggage disposition portion). Accordingly, the vehicle 1 according to the embodiment is configured to more smoothly load the luggage 54 in the vehicle interior 6 through the partial door opening 50.

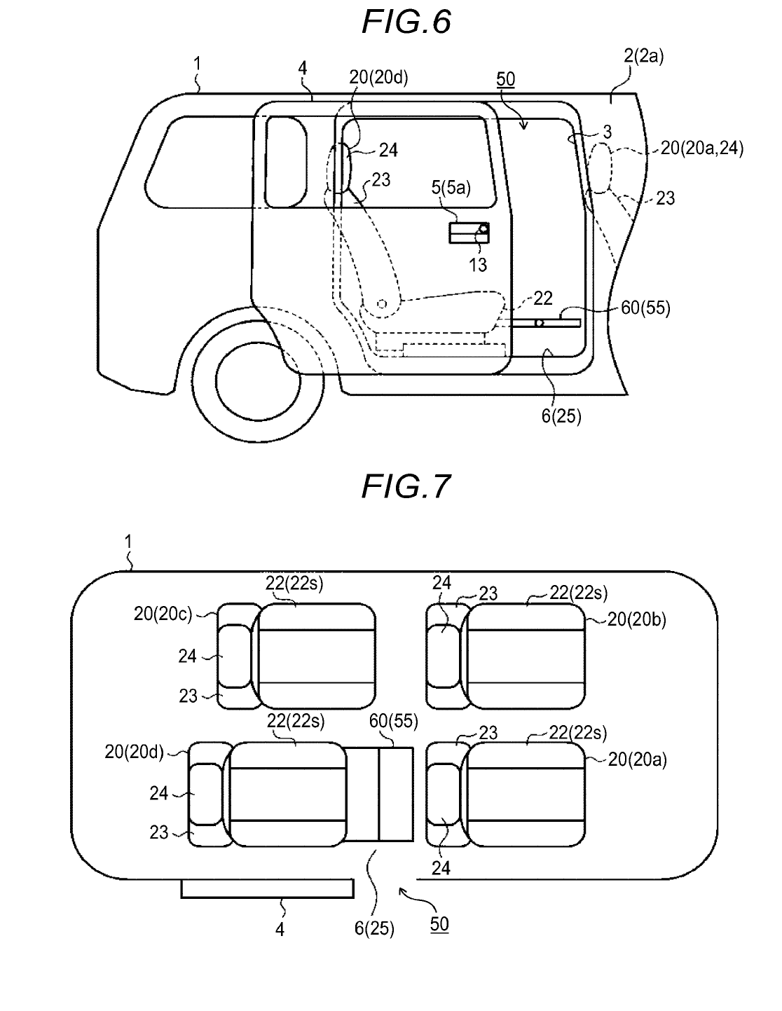

Specifically, as illustrated in FIG. 1, FIG. 2, FIG. 6 and FIG. 7, the seat ECU 21 according to the embodiment moves a door opening side rear seat 20d which is positioned on the side of the slide door 4 in the opening operation direction, that is, to the rear side of the vehicle (left side, in each drawing) as forming control of the luggage disposition portion in a case where the slide door 4 performs the partial opening operation. Specifically, the seat ECU 21 moves the door opening side rear seat 20d to the rearmost end of the slide position Pxs. Accordingly, the door opening side rear seat 20d is configured to be spaced apart from the partial door opening 50 which is formed by the partial opening of the slide door 4 being performed.

In addition, as illustrated in FIG. 3, in the door opening side rear seat 20d according to the embodiment, a luggage tray 60 as a luggage disposition member is stored in the lower side of the seat cushion 22. The seat ECU 21 according to the embodiment is configured to deploy the luggage tray 60 in the front side of the door opening side rear seat 20d in the lower side of the seat cushion 22, along with movement of the door opening side rear seat 20d in the rear direction.

Specifically, the luggage tray 60 according to the present embodiment is configured to include a first tray 61 which projects from the front end portion of the door opening side rear seat 20d in the front direction and a second tray 62 which is rotatably connected to the first tray 61 through a joint 60j provided to a tip of the first tray 61. In other words, in the luggage tray 60, at the time of being stored, the first tray 61 is retracted into the door opening side rear seat 20d as well as the second tray 62 is rotated in an erected direction (in FIG. 3, in the counterclockwise direction) in conjunction with the retracting operation of the first tray 61. Accordingly, the luggage tray 60 is adapted to be folded integrally with the front end portion of the door opening side rear seat 20d.

In addition, in the luggage tray 60, the first tray 61 and the second tray 62 are substantially horizontal to each other by the second tray 62 being rotated in the tilting direction (in the clockwise direction, in FIG. 3) in conjunction with the projecting operation of the first tray 61 which projects in the front direction of the door opening side rear seat 20d at the time of deployment. Accordingly, the luggage tray 60 according to the embodiment is configured to be a state of being capable of disposing luggage 54 on the upper side of the first tray 61 and the second tray 62.

Further, a tray actuator 65 which is capable of deploying the luggage tray 60 and performing a storing operation using a motor 63 as a driving source is provided in the door opening side rear seat 20d according to the present embodiment. In other words, the seat ECU 21 according to the present embodiment deploys the luggage tray 60 in the front direction of the door opening side rear seat 20d in the lower side of the seat cushion 22 by controlling the operation of the tray actuator 65. Accordingly, the luggage disposition portion 55 is configured to be formed in the upper side of the floor portion 25 facing the vehicle outside through the partial door opening 50, that is, in a position which is loadable the luggage 54 in the vehicle interior 6 through the partial door opening 50.

In addition, as illustrated in FIG. 1, FIG. 2, FIG. 6 and FIG. 7, the seat ECU 21 according to the embodiment tilts the seat back 23 of the door opening side front seat 20a in the front direction as forming control of the luggage disposition portion in a case where the slide door 4 performs the partial opening operation. Specifically, the seat ECU 21 returns the seat back 23 to a neutral position (see FIG. 5 and FIG. 6) in a case where the seat back 23 of the door opening side front seat 20a is in a state of being further tilted in the rear direction than the neutral position (see FIG. 1 and FIG. 2). Accordingly, the seat back 23 is configured not to be interfered with the luggage 54 when the luggage 54 is loaded in the vehicle interior 6 through the partial door opening 50, by the seat back 23 of the door opening side front seat 20a is spaced apart from the partial door opening 50.

Next, processing procedure of forming control of the luggage disposition portion which is performed by the seat ECU 21 according to the embodiment will be described.

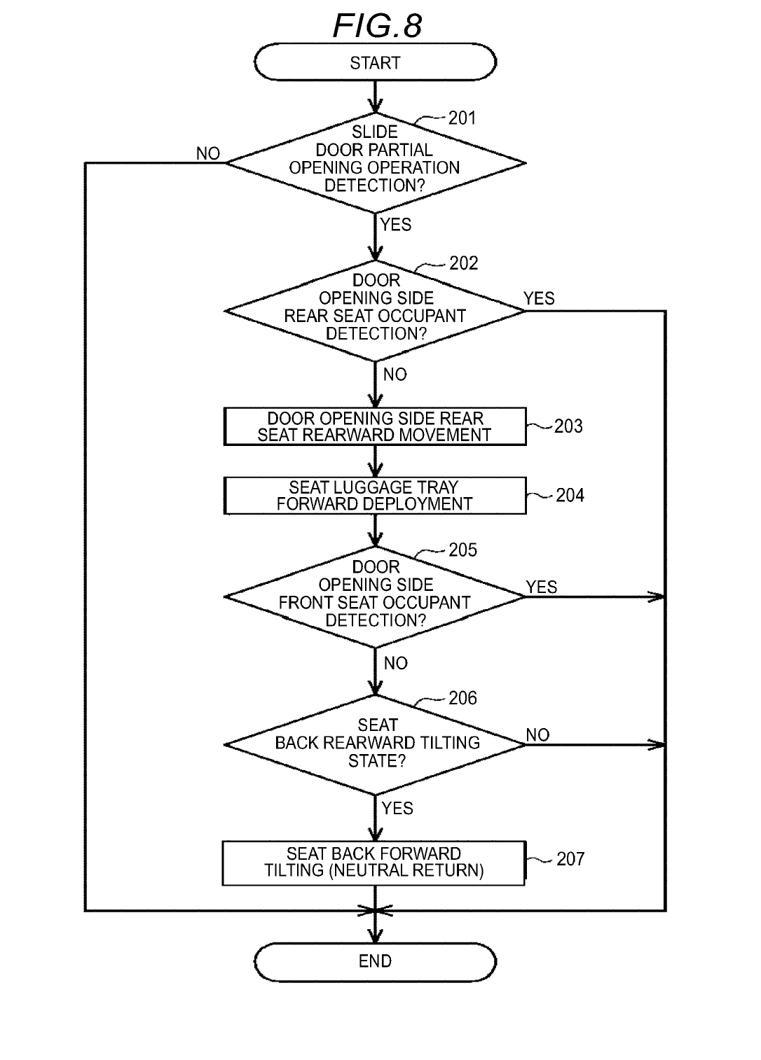

As illustrated in a flow chart in FIG. 8, the seat ECU 21 according to the embodiment first determines whether or not an occupant seats on the door opening side rear seat 20d (step 202) which is positioned on the side of the slide door 4, in a case where the partial opening operation of the slide door 4 is detected (step 201: YES). In a case where an occupant does not seat on the door opening side rear seat 20d (step 202: NO), the door opening side rear seat 20d is moved to the rearmost end of the slide position Pxs (step 203) and the luggage tray 60 which is stored in the lower side of the seat cushion 22 is deployed in the front side of the door opening side rear seat 20d (step 204).

Next, the seat ECU 21 determines whether or not an occupant seats on the door opening side front seat 20a which is positioned in the vicinity of the partial door opening 50 (step 205). Further, in a case where an occupant does not seat on the door opening side front seat 20a (step 205: NO), subsequently, the seat ECU 21 determines whether or not the seat back 23 of the door opening side front seat 20a is in a state of being further tilted than the neutral position in the rear direction (step 206). In a case where the seat back 23 is in a state of being further tilted than the neutral position in the rear direction (step 206: YES), the seat back 23 of the door opening side front seat 20a is tilted in the front direction and thus is returned to the neutral position (step 207).

In the step 206, the seat ECU 21 according to the embodiment does not perform the processing of step 207, in a case where the seat back 23 is not in a state of being further tilted than the neutral position (step 206: NO). In addition, in step 205, in a case where the seat ECU 21 determines that an occupant seats on the door opening side front seat 20a (step 205: YES), processing of step 206 and step 207 is not performed. Further, in step 202, in a case where the seat ECU 21 determines that an occupant seats on the door opening side rear seat 20d (step 202: YES), processing of step 203 or later is not performed. In step 201, in a case where the partial opening operation of the slide door 4 is not detected (step 201: NO), processing of step 202 or later is not performed.

Hereinafter, according to the present embodiment, functions and effects as follows can be obtained.

(1) In other words, the partial door opening 50 is formed on the front end side of the slide door 4, by the slide door 4 being opened in the rear direction of the vehicle. Therefore, accordingly, the luggage disposition portion 55 can be formed on the floor portion 25 facing the vehicle outside through the partial door opening 50, that is, in a position which is loadable the luggage 54 through the partial door opening 50, by the door opening side rear seat 20d which is positioned on the side of the slide door 4 being moved to the rear side of the vehicle which is the opening operation direction of the slide door 4. Accordingly, the luggage 54 is more smoothly loadable in a vehicle interior 6 through the partial door opening 50.

(2) In addition, the luggage disposition portion 55 which is more smoothly and stably loadable the luggage can be formed regardless of the shape of the floor portion 25 facing the vehicle outside through the partial door opening 50, by the luggage tray 60 which is stored in the lower side of the seat cushion 22 being deployed in the front side of the door opening side rear seat 20d. In particular, the luggage tray 60 can be deployed even in a case where a placed object exists on the seat cushion 22, by the luggage tray 60 being deployed in the lower side of the seat cushion 22. Along with this, adhesion of dirt and water can be avoided by the luggage being directly loaded on the floor portion 25.

(3) Further, the seat back 23 is not interfered with the luggage 54 when the luggage 54 is loaded in the vehicle interior 6 through the partial door opening 50, by the seat back 23 of the door opening side front seat 20a being tilted in the front direction and thus is spaced apart from the partial door opening 50. Accordingly, the luggage 54 is more smoothly loadable in the vehicle interior 6 through the partial door opening 50.

(4) In addition, in a case where an occupant seats on the door opening side rear seat 20d, control of movement in the rear direction of the door opening side rear seat 20d and deployment control of the luggage tray 60 are not performed. Further, in a case where an occupant seats on the door opening side front seat 20a, tilting (neutral return) control of the seat back 23 in the front direction is not performed. Accordingly, high reliability and safety can be secured.

### Second Embodiment

Hereinafter, a second embodiment related to a method for controlling a vehicle seat and a device for controlling a vehicle seat will be described with reference to drawings. For convenience of description, the same configuration as that of the first embodiment will be denoted by the same reference numeral and the description thereof will be omitted.

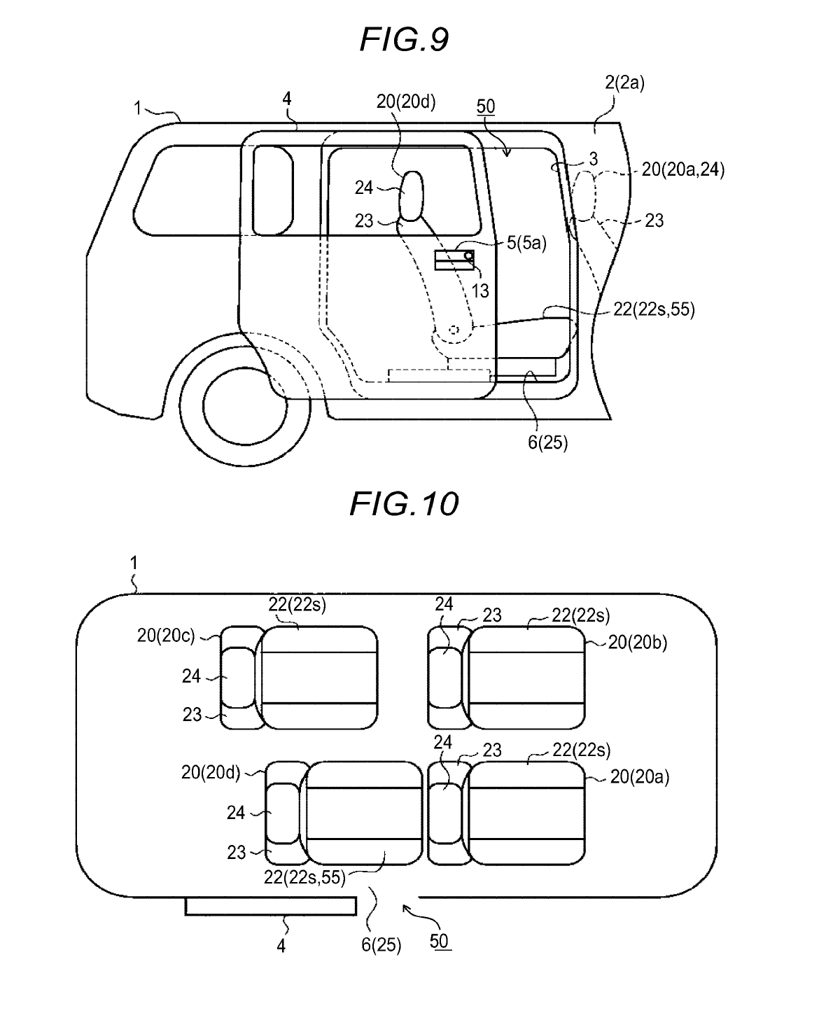

As illustrated in FIG. 9 and FIG. 10, the seat ECU 21 according to the present embodiment moves the door opening side rear seat 20d which is positioned on the side of the slide door 4 in the closing operation direction, that is, to the front side of the vehicle (right side, in each drawing) as forming control of the luggage disposition portion in a case where the slide door 4 performs the partial opening operation. Specifically, the seat ECU 21 moves the door opening side rear seat 20d to the foremost end of the slide position Pxs. Accordingly, the seat cushion 22 of the door opening side rear seat 20d is configured to be moved to a position facing the vehicle outside through the partial door opening 50 which is formed by the slide door 4 performing partial opening operation, that is, to a position which is loadable the luggage 54 in the vehicle interior 6 through the partial door opening 50.

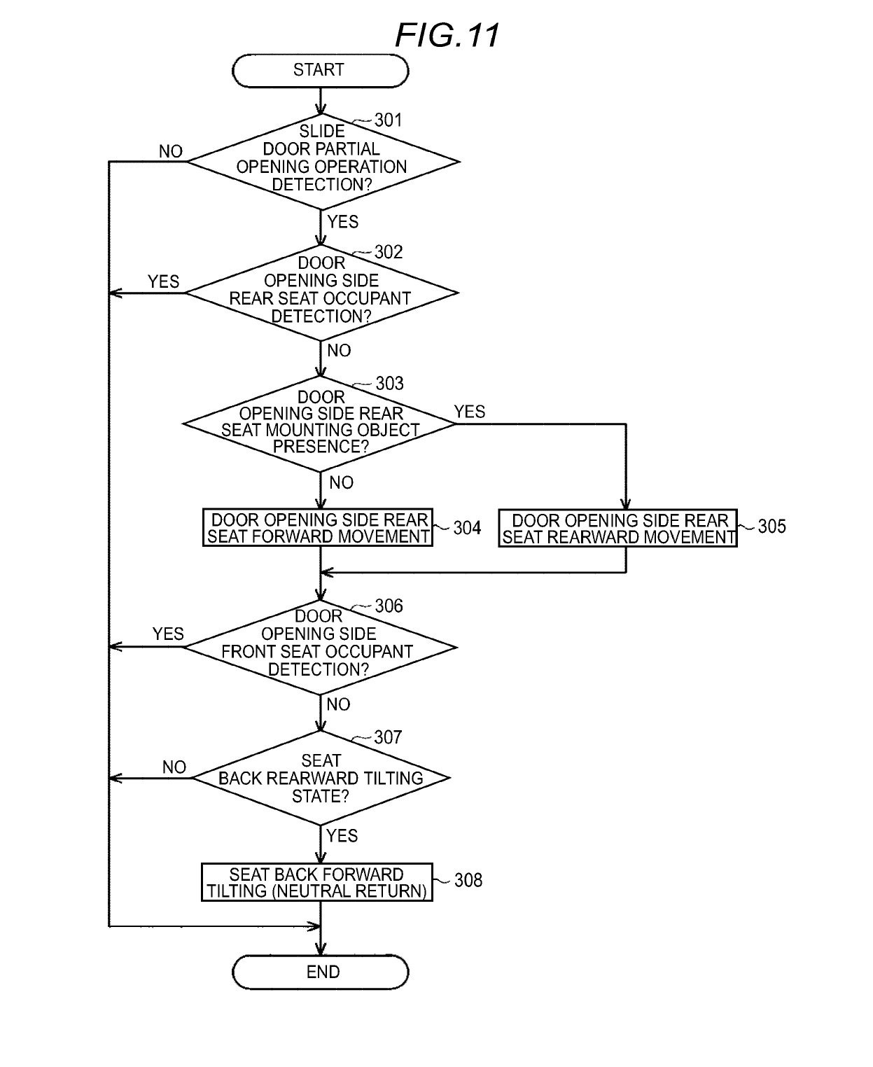

Specifically, as illustrated in a flow chart in FIG. 11, in a case of detecting the partial opening operation of the slide door 4 (step 301: YES), the seat ECU 21 according to the embodiment first determines whether or not an occupant seats on the door opening side rear seat 20d (step 302). Further, in a case where an occupant does not seat on the door opening side rear seat 20d (step 302: NO), subsequently, the seat ECU 21 determines whether or not a placed object is detected on the seat cushion 22 of the door opening side rear seat 20d (step 303). In a case where a placed object is not detected on the seat cushion 22 (step 303: NO), with respect to the door opening side rear seat 20d which is positioned on the side of the slide door 4, the door opening side rear seat 20d is moved to the foremost end of the slide position Pxs (step 304).

On the other hand, in step 303, in a case where a placed object is detected on the seat cushion 22 of the door opening side rear seat 20d (step 303: YES), the seat ECU 21 according to the embodiment moves the door opening side rear seat 20d to the rearmost end of the slide position Pxs (step 305), as in the first embodiment. In the embodiment, deployment control of the luggage tray 60 (see FIG. 8, step 204) is not performed as in the first embodiment.

Further, in the step 304 or in the step 305, in a case where the door opening side rear seat 20d is moved in any direction of the front direction and the rear direction, subsequently, the seat ECU 21 according to the embodiment determines whether or not an occupant seats on the door opening side front seat 20a (step 306) and whether or not the seat back 23 is further tilted in the rear direction than the neutral position (step 307). As in the first embodiment, as the condition which satisfies the occupant non-detection requirement and the seat back tilting requirement in the rear direction (step 306: NO, step 307: YES), the seat back 23 of the door opening side front seat 20a is moved to be tilted in the front direction and then is returned to the neutral position (step 308).

Hereinafter, according to the embodiment, functions and effects as follows can be obtained.

(1) In other words, the seat cushion 22 can be disposed on a position facing the vehicle outside through the partial door opening 50, that is, a position on which the luggage 54 is loadable through the partial door opening 50, by the door opening side rear seat 20d which is positioned on the side of the slide door 4 being moved to the vehicle front side which is the closing operation direction of the slide door 4. Accordingly, the luggage 54 is more smoothly loadable in the vehicle interior 6 through the partial door opening 50, by the seating surface 22s of the seat cushion 22 using as the luggage disposition portion 55.

(2) In addition, in a case where whether or not a placed object is detected on the seat cushion 22 of the door opening side rear seat 20d is determined and a placed object is not detected, a placed object on the seat cushion 22 can be avoided to be hindered when the luggage 54 is loaded, by the door opening side rear seat 20d being moved in the front direction.

(3) Further, in a case where a placed object is detected on the seat cushion 22 of the door opening side rear seat 20d, the door opening side rear seat 20d is moved in the vehicle rear side which is the opening operation direction of the slide door 4 and the luggage disposition portion 55 is formed on the front side of the door opening side rear seat 20d, that is, on the floor portion 25 facing the vehicle outside through the partial door opening 50. Accordingly, the luggage 54 is smoothly loadable in the vehicle interior 6 through the partial door opening 50 even in a case where a placed object is on the seat cushion 22.

The embodiment may be modified as follows.

In each embodiment, in a case where the operating switch 13 which is provided in the outside door handle 5a performs so called “long pressing operation”, the slide door 4 is moved to the fully opened position Xo and in a case where the operating switch 13 performs so called “short pressing operation”, the slide door 4 performs the partial opening operation. However, it is not limited thereto, and the operating input method for requesting the partial opening operation of the slide door 4, for example, such as change of operation number with respect to the operating input portion such as the operating switch 13 (two times or three times pressing) or the like may be set arbitrarily.

In each embodiment, the door ECU 11 can detect start of the partial opening operation control which is performed by the door ECU 11, based on the control information Idc of the slide door 4 which is obtained from the door ECU 11. However, it is not limited thereto and the partial opening operation of the slide door 4 may be configured to be detected afterwards. Even in a case where the slide door 4 manually performs the partial opening operation, forming control of the luggage disposition portion may be performed.

In each embodiment, specifically, although the rear seat (door opening side rear seat 20d) is positioned at the side of the slide door 4, the front seat may be positioned at the slide door side. The opening operation direction of the slide door may be configured to be in the vehicle front side.

In other words, for example, in configuration of the front seat being positioned at the side of the slide door which is opened to the vehicle front side, the luggage disposition portion 55 can be formed on the floor portion 25 facing the vehicle outside through the partial door opening 50 which is formed on the rear side of the front seat or on the rear portion seat, by the front seat being moved to the vehicle front side which is the opening operation direction of the slide door. The luggage 54 can be disposed on the position facing the vehicle outside through the partial door opening 50, that is, can be disposed on the position on which the luggage is loadable through the partial door opening 50 using the seat cushion 22 as the luggage disposition portion 55, by the front seat being moved to the vehicle rear side which is the opening operation direction of the slide door.

In each embodiment, in a case where the seat back 23 of the door opening side front seat 20a is in a state of being further tilted in the rear direction than the neutral position, the seat back 23 is spaced apart from the partial door opening 50, by the seat back 23 being tilted in the front direction and returned to the neutral position. However, it is not limited thereto and starting condition of tilting control so that the seat back 23 is spaced apart from the partial door opening 50 and tilting amount (tilting position) of the seat back 23 may be set arbitrarily. Further, for example, in the configuration of the front seat which is positioned on the side of the slide door which performs the opening operation to the vehicle front side being moved to the vehicle rear side which is the closing operation direction of the slide door, that is, in a case where the seat cushion 22 of the front seat is used as the luggage disposition portion 55, the seat cushion 22 may be configured to be spaced apart from the partial door opening 50 by the seat back 23 being tilted in the rear direction. With respect to the seat 20 on which the seat back 23 is disposed in the vicinity of the partial door opening 50, configuration in which control of the seat back 23 of the seat 20 being tilted to the direction along which the seat back 23 is spaced apart from the partial door opening is not performed is also not excluded.

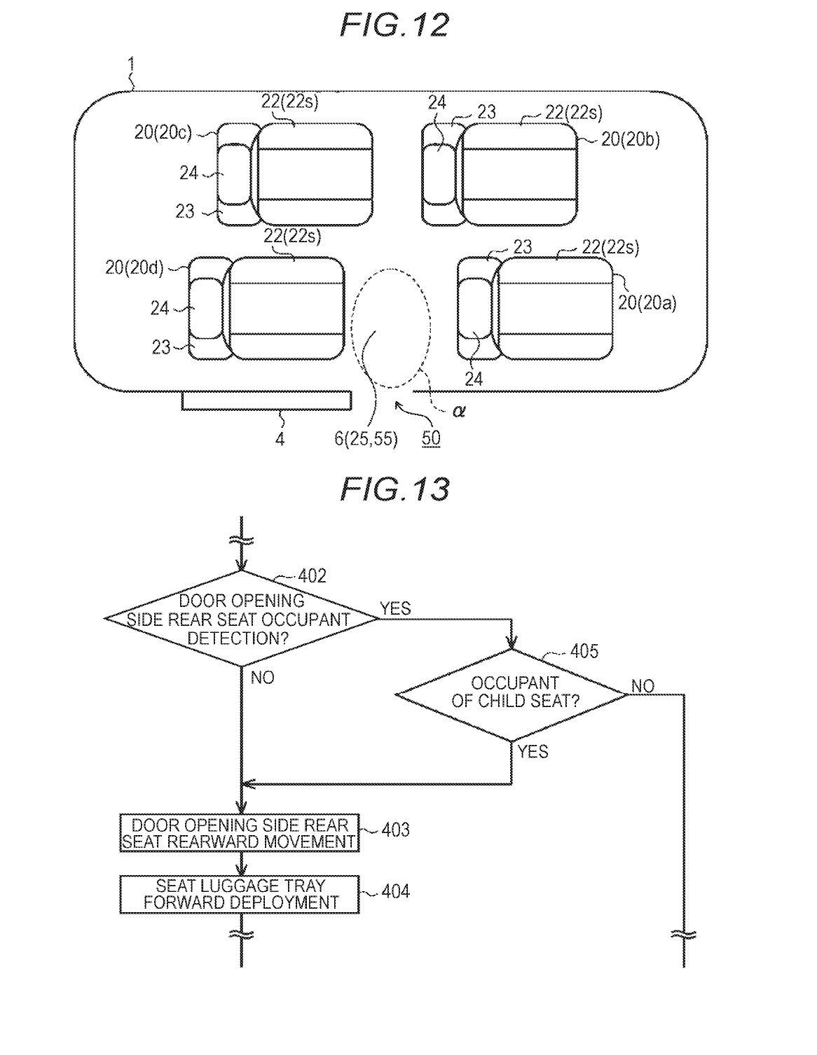

In addition, as illustrated in FIG. 12, the door opening side front seat 20a may be configured to be spaced apart from the partial door opening 50 by the door opening side front seat 20a being moved in the front direction. The seat back 23 of the door opening side front seat 20a is hard to be interfered with the luggage, when the luggage is loaded in the vehicle interior 6 through the partial door opening 50, by adopting such a configuration. Application to the configuration (see FIG. 10) in which the door opening side rear seat 20d is moved to the vehicle front side as a forming control of the luggage disposition portion can also achieve the same effect. In the configuration in which the door opening side rear seat 20d is moved to the vehicle rear side as a forming control of the luggage disposition portion, the luggage disposition portion 55 which is formed on (floor portion 25 of) the front side of the door opening side rear seat 20d can be expanded.

Further, the opening operation direction of the slide door may be configured to be in the vehicle front side. In other words, in this case, the rear seat which is disposed on the vehicle rear side which is the closing operation direction of the slide door is moved in the rear direction with respect to the front seat which is positioned on the side of the slide door. Accordingly, interference between the seat back 23 and the luggage with each other can be avoided when the luggage is loaded through the partial door opening 50. In a configuration in which the front seat which is positioned in the side of the slide door as the forming control of the luggage disposition portion, the luggage disposition portion 55 which is formed on (floor portion 25 of) the rear side of the front seat can be expanded.

In each embodiment, it is determined whether or not an occupant seats on the door opening side rear seat 20d which is positioned on the side of the slide door 4 and in a case where an occupant seats (see FIG. 8 to FIG. 11, step 202: YES, step 302: YES), operation control of the seat 20 for forming the luggage disposition portion 55 is not performed.

However, it is not limited thereto and as illustrated in a flow chart of FIG. 13, in a case where seating of an occupant is detected on the door opening side rear seat 20d which is positioned on the side of the slide door 4 (step 402: YES), it is determined that whether or not the occupant is an occupant (child) who should be seated on a child seat which is provided to the door opening side rear seat 20d (step 405). In a case where it is determined that an occupant which seats on the child seat is detected (step 405: YES), it may be configured that the door opening side rear seat 20d is moved in the rear direction (step 403), and the luggage tray 60 which is stored in the lower side of the door opening side rear seat 20d is deployed in the front side of the door opening side rear seat 20d (step 404).

In other words, in a case where an occupant of the door opening side rear seat 20d is a child which seats on the child seat on the seat cushion 22, feet of the child are hard to be interfered with the luggage tray 60 which is deployed in the lower side of the seat cushion 22 and the luggage which is loaded to the luggage tray 60. Therefore, according to the configuration, even in the situation described above, the luggage 54 is smoothly loadable in the vehicle interior 6 through the partial door opening 50.

In the first embodiment, the door opening side rear seat 20d is moved to the rearmost end of the slide position Pxs (see FIG. 7), and in the second embodiment, the door opening side rear seat 20d is moved to the foremost end of the slide position Pxs (see FIG. 10). However, it is not limited thereto and as the forming control of the luggage disposition portion, the movement amount (movement position) when the seat 20 which is positioned on the side of the slide door 4 is moved to any direction of the front direction and the rear direction may be set arbitrarily.

In addition, in the second embodiment, the deployment control of the luggage tray 60 as in the first embodiment is not performed. However, it is not limited thereto and in a case where the luggage tray 60 is provided in the door opening side rear seat 20d, the deployment control of the luggage tray 60 may be performed. In the first embodiment, there may be a configuration which does not perform the deployment control of the luggage tray 60, that is, a configuration in which the floor portion 25 of front side of the door opening side rear seat 20d facing the vehicle outside through the partial door opening 50 is used as the luggage disposition portion 55.

In the second embodiment, in a case where a placed object is detected on the seat cushion 22 of the door opening side rear seat 20d (step 303: YES), as in the first embodiment, the door opening side rear seat 20d is moved in the rear direction (step 305). However, it is not limited thereto and in a case where a placed object is detected on the seat cushion 22, it may be configured that the movement in the front direction and in the rear direction of the door opening side rear seat 20d is not performed. Without performing the detection of a placed object on the seat cushion 22, the door opening side rear seat 20d may be moved in the front direction.

Further, in a configuration in which the seating surface 22s of the seat cushion 22 is used in the luggage disposition portion 55, the operation of the seat 20 may be controlled so that the seating surface 22s is flattened or expanded.

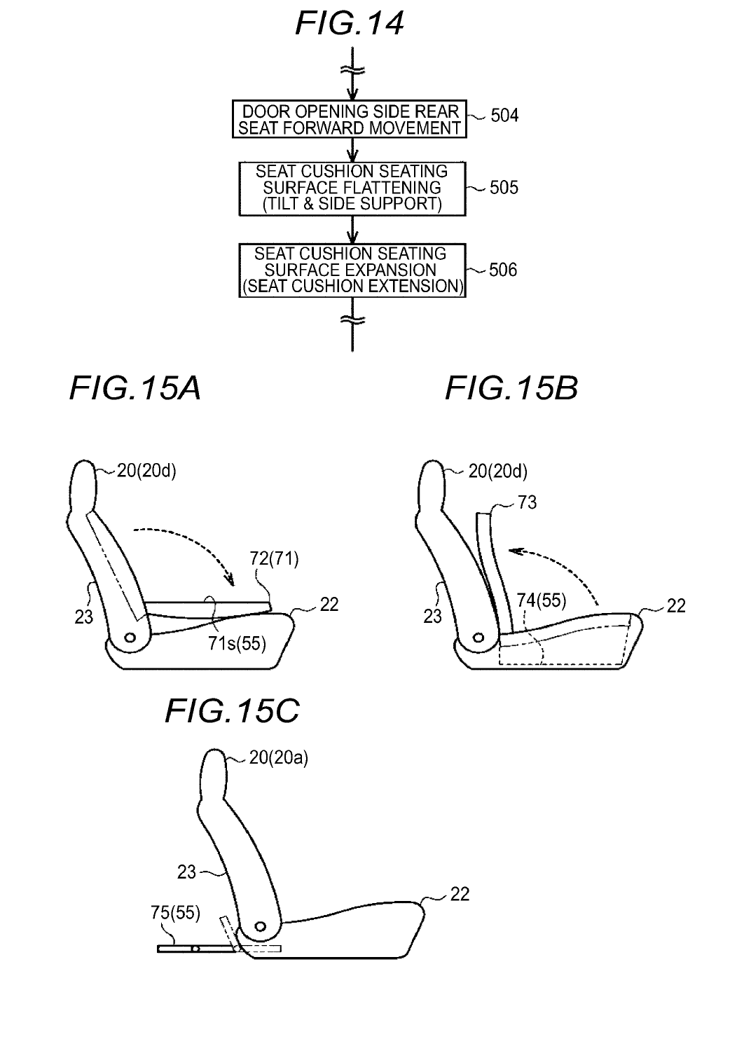

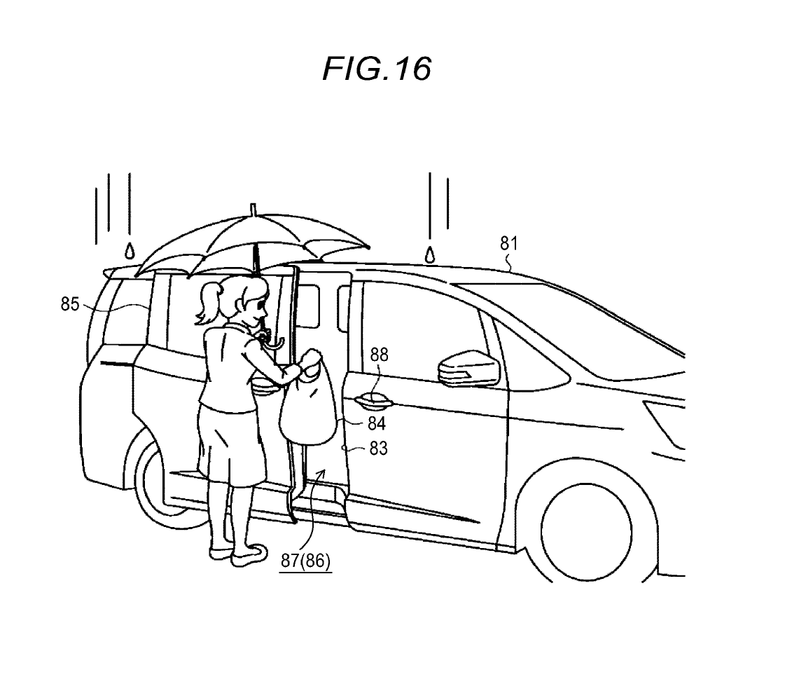

For example, as in a flow chart of FIG. 14, the door opening side rear seat 20d which is positioned on the side of the slide door 4 is moved in the front direction (step 504) and the seating surface 22s is flattened (step 505), by tilting (tilting adjustment) mechanism of the seat cushion 22, side support adjustment mechanism, or the like which is provided in the door opening side rear seat 20d. Further, the seating surface 22s may expand (step 506) or the like, by front side extension function of the seat cushion 22.

By adopting such a configuration, the luggage is more smoothly and stably loadable using the seating surface 22s of the seat cushion 22 as the luggage disposition portion 55. Any one of flattening and expansion of the seat cushion 22 may be performed.

In the first embodiment, although the luggage tray 60 which is deployed toward the front side of the door opening side rear seat 20d is provided in the lower side of the seat cushion 22 in the door opening side rear seat 20d, the configuration of a luggage disposition member which is deployed in the forming control of the luggage disposition portion is not necessarily limited thereto.

For example, as illustrated in FIG. 15A, in a case of the seat 20 (20d) having a luggage disposition member 72 of which a back surface 71s becomes the luggage disposition portion 55 by a backrest portion 71 of the seat back 23 being collapsed in the front direction, the luggage disposition member 72 may be configured to be deployed. As illustrated in FIG. 15B, in a case of the seat 20 (20d) having a luggage disposition member 74 which forms the luggage disposition portion 55 in the inside of the seat cushion 22 by a seating portion 73 of the seat cushion 22 being jumped in the upper direction, the luggage disposition member 74 may be configured to be deployed.

In a configuration in which any one of the luggage disposition members 72 and 74 illustrated in FIG. 15A and FIG. 15B is provided in the door opening side rear seat 20d, the door opening side rear seat 20d may be moved in the front direction, that is, in the closing operation direction of the slide door 4 in conjunction with the deployment of the luggage disposition members 72 and 74. Accordingly, the luggage 54 is more smoothly loadable in a vehicle interior 6 through the partial door opening 50. As the forming control of the luggage disposition portion, the luggage disposition members 72 and 74 (or luggage tray 60) may be configured to be deployed without the door opening side rear seat 20d being moved.

Further, as illustrated in FIG. 15C, with respect to the door opening side front seat 20a, in a case where a luggage tray 75 which is deployed toward the rear side is provided in the lower side of the seat cushion 22, the luggage tray 75 may be configured to be deployed. Even in a case where such a luggage tray 75 is used in the luggage disposition portion 55, the luggage 54 is smoothly loadable in the vehicle interior 6 through the partial door opening 50.

In addition, in the first embodiment, the tray actuator 65 which is capable of performing a deploying operation and a storing operation of the luggage tray 60 using the motor 63 as a driving source is provided in the door opening side rear seat 20d. However, it is not limited thereto and for example, a drive source may be arbitrarily changed such as using of an elastic member such as a spring or the like. In other words, as the forming control of the luggage disposition portion, at least the luggage disposition members (60, 72, 74 and 75) may be deployed and the storing operation can be manually performed.

In each embodiment, as forming control of the luggage disposition portion, the operation of the door opening side rear seat 20d and the door opening side front seat 20a is controlled. However, it is not limited thereto and the same operation control may be performed with respect to each seat 20 (20b and 20c) arranged adjacent to each other in the position which is further spaced apart from the partial door opening 50 than each seat 20 (20a and 20d). At least three seats 20 may be also applied to the configuration arranged in a vehicle width direction. By adopting such a configuration, the luggage disposition portion 55 which is loadable larger luggage may be formed.

“Position which is loadable the luggage 54 through the partial door opening 50” does not necessarily have to be a position that can be seen from the outside of the vehicle. For example, if the position is a position in which the luggage is capable of being disposed while a hand is inserted into the vehicle interior 6 through the partial door opening 50, the position may be a position hidden by the slide door 4.

In addition, at the time of the partial opening operation of the slide door 4, the luggage disposition portion 55 formed as described above and the vicinity thereof may be illuminated. By adopting such a configuration, even at night, the luggage 54 is more smoothly loadable in the vehicle interior 6 through the partial door opening 50. Further, at this time, illuminated areas may be limited (for example, see FIG. 12, spot illuminated area a on the floor portion 25). For example, an illumination device may be provided in a position close to the luggage disposition portion 55, such as the rear surface portion of the seat back 23 in the door opening side front seat 20a or the lower side of the seat cushion 22 in the door opening side rear seat 20d. Accordingly, a crime prevention effect can be expected that the third person is hard to confirm the appearance of the user who operates the slide door 4.

In each embodiment, an occupant seating state and presence or absence of a placed object in each seat 20 are detected, based on the output signal S1 of the seating sensor 41 and the output signal S2 (Ws) of the load sensor 42. However, it is not limited thereto and the method for detecting the occupant seating state and for detecting a placed object on the seat cushion 22 may be changed arbitrarily.

It is preferable that a method for controlling a vehicle seat according to an aspect of this disclosure includes detecting a partial opening operation that a slide door which is provided in a side surface of a vehicle operates from a fully closed position to a position in the middle of reaching a fully opened position of the slide door; and controlling an operation of the seat which is provided in a vehicle interior in order to form a luggage disposition portion on a position on which the luggage is loadable through door opening of a side surface of the vehicle which is formed by the partial opening operation, in a case where the slide door performs the partial opening operation.

According to this configuration, the luggage is more smoothly loadable in the vehicle interior through the partial door opening, by using the luggage disposition portion which is formed by an operation of the seat which is provided in the vehicle interior.

In the method for controlling a vehicle seat according to the aspect of this disclosure, the seat which is positioned on the side of the slide door in a vehicle width direction is moved in an opening operation direction of the slide door, when the operation of the seat is controlled in order to form the luggage disposition portion.

That is, the partial door opening is formed on an end portion of side opposite to the opening operation direction, by the slide door being opened. Accordingly, the luggage disposition portion can be formed on a floor portion of the position on which the luggage is loadable through the partial door opening, by the seat positioned on the side of the slide door being moved in the opening operation direction of the slide door. Accordingly, the luggage is smoothly loadable in the vehicle interior through the partial door opening.

In the method for controlling a vehicle seat according to the aspect of this disclosure, the seat which is positioned on the side of the slide door in a vehicle width direction is moved in a closing operation direction of the slide door, when the operation of the seat is controlled in order to form the luggage disposition portion.

That is, a seat cushion of the seat can be disposed on the position on which the luggage is loadable through the partial door opening, by the seat positioned on the side of the slide door being moved in the closing operation direction of the slide door. Accordingly, the luggage is more smoothly loadable in the vehicle interior through the partial door opening, by a seating surface of the seat cushion being used as the luggage disposition portion.

In the method for controlling a vehicle seat according to the aspect of this disclosure, a placed object is detected on a seat cushion which forms a seating surface of the seat, and the seat is moved in the closing operation direction of the slide door in a case where the placed object is not detected on the seat which is positioned on the side of the slide door.

According to this configuration, a placed object on the seat cushion can be prevented from interfering the luggage when the luggage is loaded.

In the method for controlling a vehicle seat according to the aspect of this disclosure, the seat is moved in an opening operation direction of the slide door, in a case where the placed object is detected on the seat which is positioned on the side of the slide door.

In the method for controlling a vehicle seat according to the aspect of this disclosure, a seat back of the seat is tilted in a direction which is spaced apart from the door opening with respect to the seat on which the seat back is disposed in the vicinity of the door opening, when the operation of the seat is controlled in order to form the luggage disposition portion.

According to this configuration, the seat back can be prevented from being interfered with the luggage when the luggage is loaded in the vehicle interior through the partial door opening. Accordingly, the luggage is more smoothly loadable in the vehicle interior through the partial door opening.

In the method for controlling a vehicle seat according to the aspect of this disclosure, a luggage disposition member which is provided in the seat positioned in the vicinity of the door opening is deployed, when the operation of the seat is controlled in order to form the luggage disposition portion.

In the method for controlling a vehicle seat according to the aspect of this disclosure, the luggage disposition member which is stored in the lower side of the seat cushion which forms the seating surface of the seat is deployed in the lower side of the seat cushion, when the luggage disposition member is deployed.

According to this configuration, the luggage is more smoothly loadable in the vehicle interior through the partial door opening, by using the luggage disposition member which is deployed.

In the method for controlling a vehicle seat according to the aspect of this disclosure, an occupant seating state is detected on the seat, and the operating control in order to form the luggage disposition portion is not performed with respect to the seat on which the occupant seats.

In the method for controlling a vehicle seat according to the aspect of this disclosure, a seat is moved in a closing operation direction of the slide door when being disposed on the side of the closing operation direction of the slide door with respect to the seat which is positioned on the side of the slide door, when the seat operation is controlled in order to form the luggage disposition portion.

In the method for controlling a vehicle seat according to the aspect of this disclosure, an occupant seating state is detected on the seat, and the seat which is positioned on the side of the slide door is moved in the opening operation direction of the slide door and the luggage disposition member which is provided in the seat which is positioned on the side of the slide door is deployed from the lower side to the front side of the seat cushion, in a case where an occupant which seats on a child seat is detected on the seat which is positioned on the side of the slide door, when the seat operation is controlled in order to form the luggage disposition portion.

In the method for controlling a vehicle seat according to the aspect of this disclosure, a seating surface of the seat cushion of the seat is flattened, when an operation of the seat is controlled in order to form the luggage disposition portion.

In the method for controlling a vehicle seat according to the aspect of this disclosure, a seating surface of the seat cushion of the seat is expanded, when an operation of the seat is controlled in order to form the luggage disposition portion.

In the method for controlling a vehicle seat according to the aspect of this disclosure, the same operation control is performed to the plurality of seats arranged in a vehicle width direction, when an operation of the seat is controlled in order to form the luggage disposition portion.

According to this configuration, high reliability and safety can be secured.

It is preferable that a device for controlling a vehicle seat according to another aspect of this disclosure includes a partial opening operation detecting portion which detects a partial opening operation that a slide door which is provided in a side surface of a vehicle operates from a fully closed position to a position in the middle of reaching a fully opened position of the slide door; and a seat controlling unit which controls an operation of the seat which is provided in a vehicle interior so that a luggage disposition portion is formed on a position on which the luggage is loadable through door opening of a side surface of the vehicle which is formed by the partial opening operation, in a case where the slide door performs the partial opening operation.

In the device for controlling a vehicle seat according to the aspect of this disclosure, it is preferable that the seat controlling unit causes the seat positioned on the side of the slide door to be moved in an opening operation direction of the slide door.

In the device for controlling a vehicle seat according to the aspect of this disclosure, it is preferable that the seat controlling unit causes the seat positioned on the side of the slide door to be moved in a closing operation direction of the slide door.

In the device for controlling a vehicle seat according to the aspect of this disclosure, the seat controlling unit tilts a seat back of the seat in a direction which is spaced apart from a door opening with respect to the seat on which the seat back is disposed in the vicinity of the door opening.

According to the aspects of this disclosure, the luggage is more smoothly loadable in the vehicle interior through the partial door opening.

Next, technical ideas that can be grasped from the above embodiments will be described in conjunction with effects.

(a) In the method for controlling a vehicle seat, the step for controlling operation of the seat in order to form the luggage disposition portion includes a step for moving a second seat which is disposed on the closing operation direction of the slide door in the closing operation direction of the slide door with respect to the seat which is positioned on the side of the slide door.

According to the configuration, the seat back of the second seat can be prevented from being interfered with the luggage when the luggage is loaded in the vehicle interior through the partial door opening. As forming control of the luggage disposition portion, in a configuration in which the seat (first seat) which is positioned on the side of the slide door is moved to the opening operation direction of the slide door, the luggage disposition portion which is formed in the closing operation direction of the slide door can be expand.

(b) In the method for controlling a vehicle seat, the step for deploying the luggage disposition member deploys the luggage disposition member which is stored in the lower side of the seat cushion from the lower side of the seat cushion.

According to the configuration, even in a case where a placed object is in the seat cushion, the luggage disposition member can be deployed.

(c) The method for controlling a vehicle seat further includes a step for detecting a seating state of an occupant on the seat, and the step for controlling an operation of the seat in order to form the luggage disposition portion includes a step for moving the seat which positions on the side of the slide door in the opening operation direction of the slide door and a step for deploying the luggage disposition member which is provided on the seat which is positioned on the side of the slide door from the lower side to the front side of the seat cushion in a case where an occupant which seats on a child seat is detected on the seat which is positioned on the side of the slide door.

In other words, in a case where an occupant on the seat which is positioned on the side of the slide door is a child which is seated on the child seat on the seat cushion, the feet of the occupant are hard to be interfered with the luggage disposition member which is deployed in the lower side of the seat cushion, and the luggage which is disposed on the luggage disposition member. Therefore, according to the configuration, even in the situation described above, the luggage is smoothly loadable in the vehicle interior through the partial door opening.

(d) In the method for controlling a vehicle seat, the seat is moved in an opening operation direction of the slide door, in a case where the placed object is detected on the seat which is positioned on the side of the slide door.

According to the configuration, even in a case where a placed object exists on the seat cushion, the luggage disposition portion can be disposed on which the luggage is loadable through the partial door opening, in the opening operation direction of the slide door other than the seat which is positioned on the side of the slide door. Accordingly, the luggage is more smoothly loadable in a vehicle interior through a partial door opening.

(e) In the method for controlling a vehicle seat, the step for controlling operation of the seat in order to form the luggage disposition portion includes a step for flattening a seating surface of the seat cushion.

(f) In the method for controlling a vehicle seat, the step for controlling operation of the seat in order to form the luggage disposition portion includes a step for expanding a seating surface of the seat cushion.

According to the configuration, the luggage is more smoothly and stably loadable using the seating surface of the seat cushion as the luggage disposition portion.

(g) In the method for controlling a vehicle seat, the step for controlling operation of the seat in order to form the luggage disposition portion performs the same operation control with respect to the plurality of seats arranged in the vehicle width direction. By adopting such a configuration, the luggage disposition portion which is loadable the larger luggage may be formed.

(h) In a device for controlling a vehicle seat, the device includes a placed object detecting portion which detects a placed object on a seat cushion. The seat controlling unit moves the seat in the closing operation direction of the slide door, in a case where the placed object is not detected on the seat which is positioned on the side of the slide door.

(i) In the device for controlling a vehicle seat, the seat controlling unit tilts a seat back of the seat in a direction which is spaced apart from a door opening with respect to the seat on which the seat back is disposed in the vicinity of the partial door opening portion.

(j) In the device for controlling a vehicle seat, the seat controlling unit deploys a luggage disposition member which is provided in the seat positioned in the vicinity of the partial door opening.

(k) In the device for controlling a vehicle seat, the device further includes a seating state detecting portion which detects an occupant seating state on the seat. The seat controlling unit does not perform the operation control for forming the luggage disposition portion with respect to the seat on which the occupant seats.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A method for controlling a vehicle seat, comprising:
detecting a partial opening operation that a slide door which is provided in a side surface of a vehicle operates from a fully closed position to a position in the middle of reaching a fully opened position of the slide door; and
controlling an operation of the seat which is provided in a vehicle interior in order to form a luggage disposition portion on a position on which luggage is loadable through door opening of a side surface of the vehicle which is formed by the partial opening operation, in a case where the slide door performs the partial opening operation.

2. The method for controlling a vehicle seat according to claim 1,
wherein the seat which is positioned on the side of the slide door in a vehicle width direction is moved in an opening operation direction of the slide door, when the operation of the seat is controlled in order to form the luggage disposition portion.

3. The method for controlling a vehicle seat according to claim 1,
wherein the seat which is positioned on the side of the slide door in a vehicle width direction is moved in a closing operation direction of the slide door, when the operation of the seat is controlled in order to form a luggage disposition portion.

4. The method for controlling a vehicle seat according to claim 3,
wherein a placed object is detected on a seat cushion which forms a seating surface of the seat, and
wherein the seat is moved in the closing operation direction of the slide door in a case where the placed object is not detected on the seat which is positioned on the side of the slide door.

5. The method for controlling a vehicle seat according to claim 4,
wherein the seat is moved in an opening operation direction of the slide door, in a case where the placed object is detected on the seat which is positioned on the side of the slide door.

6. The method for controlling a vehicle seat according to claim 1,
wherein a seat back of the seat is tilted in a direction which is spaced apart from the door opening with respect to the seat on which the seat back is disposed in the vicinity of the door opening, when the operation of the seat is controlled in order to form the luggage disposition portion.

7. The method for controlling a vehicle seat according to claim 1,
wherein a luggage disposition member which is provided in the seat positioned in the vicinity of the door opening is deployed, when the operation of the seat is controlled in order to form the luggage disposition portion.

8. The method for controlling a vehicle seat according to claim 7,
Wherein the luggage disposition member which is stored in the lower side of the seat cushion which forms the seating surface of the seat is deployed in the lower side of the seat cushion, when the luggage disposition member is deployed.

9. The method for controlling a vehicle seat according to claim 1,
wherein an occupant seating state is detected on the seat, and
wherein the operating control in order to form the luggage disposition portion is not performed with respect to the seat on which the occupant seats.

10. The method for controlling a vehicle seat according to claim 1,
wherein a seat is moved in a closing operation direction of the slide door when being disposed on the side of the closing operation direction of the slide door with respect to the seat which is positioned on the side of the slide door, when the seat operation is controlled in order to form the luggage disposition portion.

11. The method for controlling a vehicle seat according to claim 1,
wherein an occupant seating state is detected on the seat, and
wherein the seat which is positioned on the side of the slide door is moved in the opening operation direction of the slide door and the luggage disposition member which is provided in the seat which is positioned on the side of the slide door is deployed from the lower side to the front side of the seat cushion, in a case where an occupant which seats on a child seat is detected on the seat which is positioned on the side of the slide door, when the seat operation is controlled in order to form the luggage disposition portion.

12. The method for controlling a vehicle seat according to claim 1,
wherein a seating surface of the seat cushion of the seat is flattened, when an operation of the seat is controlled in order to form the luggage disposition portion.

13. The method for controlling a vehicle seat according to claim 1,
wherein a seating surface of the seat cushion of the seat is expanded, when an operation of the seat is controlled in order to form the luggage disposition portion.

14. The method for controlling a vehicle seat according to claim 1,
wherein the same operation control is performed to the plurality of seats arranged in a vehicle width direction, when an operation of the seat is controlled in order to form the luggage disposition portion.

15. A device for controlling a vehicle seat, comprising:
a partial opening operation detecting portion which detects a partial opening operation that a slide door which is provided in a side surface of a vehicle operates from a fully closed position to a position in the middle of reaching a fully opened position of the slide door; and
a seat controlling unit which controls an operation of the seat which is provided in a vehicle interior so that a luggage disposition portion is formed on a position on which luggage is loadable through door opening of a side surface of the vehicle which is formed by the partial opening operation, in a case where the slide door performs the partial opening operation.

16. The device for controlling a vehicle seat according to claim 15,
wherein the seat controlling unit causes the seat positioned on the side of the slide door to be moved in an opening operation direction of the slide door.

17. The device for controlling a vehicle seat according to claim 15,
wherein the seat controlling unit causes the seat positioned on the side of the slide door to be moved in a closing operation direction of the slide door.

18. The device for controlling a vehicle seat according to claim 15,
wherein the seat controlling unit tilts a seat back of the seat in a direction which is spaced apart from a door opening with respect to the seat on which the seat back is disposed in the vicinity of the door opening.
